(19) United States
(12) Patent Application Publication
(10) Pub. No.: US 2015/0053625 A1
(43) Pub. Date: Feb. 26, 2015

(54) ARRANGEMENT AND METHOD FOR PRODUCING A FLOW IN A WASTEWATER TREATMENT TANK

(71) Applicant: INVENT UMWELT - UND VERFAHRENSTECHNIK AG, Erlangen (DE)

(72) Inventor: Marcus Hoefken, Erlangen (DE)

(21) Appl. No.: 14/387,067

(22) PCT Filed: Mar. 20, 2013
(86) PCT No.: PCT/EP2013/055841

§ 371 Date: Sep. 22, 2014

(30) Foreign Application Priority Data
Mar. 23, 2012 (DE) 10 2012 204 724.7

(51) Int. Cl. C02F 1/74; B01F 5/10; B01F 3/04

(52) U.S. Cl. CPC C02F 1/74; B01F 3/04588; B01F 5/104; B01F 2215/0052; B01F 2215/008; C02F 2301/04
USPC 210/758; 261/84; 261/93

(57) ABSTRACT

The invention relates to an arrangement for producing a flow in a wastewater treatment tank (1), comprising a substantially horizontal bottom (B) and a horizontal mixer (2, 3, 4), which is provided in the wastewater treatment tank (1) and which has a propeller (4) driven by means of a propeller shaft (3). According to the invention, in order to save energy to produce flows, the axis (A) of the propeller shaft (3) is tilted relative to the bottom (B) by an angle α of 1 to 10° in such a way that a flow directed toward a surface (O) of the wastewater (W) can be produced by the horizontal mixer (2, 3, 4).

The invention relates to an arrangement and a method for producing a flow in a wastewater treatment tank according to the preamble of claims 1 and 6.

Such an arrangement and such a method are known, for example, from FR 1 494 983, DE-OS 1 932 640, or DE-OS 2 147 080. A horizontal mixer for producing a circulating flow is provided in a ring-shaped wastewater treatment tank. The horizontal mixer comprises a propeller, which is driven via a propeller shaft. An axis of the propeller shaft extends parallel to a horizontal bottom of the wastewater treatment tank. The propeller shaft is typically driven by means of an electric motor. Electrical energy is required to produce and maintain the circulating flow.

US 2008/0053898 A1 discloses a method for the treatment of wastewater. According thereto, an agitator is provided for producing a flow, in the case of which the axis of the propeller shaft is tilted relative to the bottom of the wastewater treatment tank. The direction of the tilt of the axis corresponds to a flow direction produced by the agitator. In this case, the axis of the propeller shaft is tilted relative to the bottom by an angle of approximately 45°. The propeller produces a flow having a flow direction that is also tilted relative to the bottom by an angle of approximately 45°. The known agitator is secured on a floatation device. Said agitator is located in the vicinity of a surface of the wastewater and is used to introduce oxygen into the wastewater.

The object of the invention is to eliminate the disadvantages of the prior art. In particular, the object is to provide an arrangement and a method with which a flow can be produced in a wastewater treatment tank with reduced energy expenditure.

This object is attained by the features of claims 1 and 6. Advantageous embodiments of the invention will become apparent from the features of claims 2 to 5 and 7 to 10.

According to the invention, the axis of the propeller shaft is tilted relative to the bottom by an angle of 1 to 10° in such a way that a flow directed toward a surface of the wastewater can be produced by the horizontal mixer.

In contrast to the prior art, it is therefore provided according to the invention that the horizontal mixer produces a flow having a flow direction that does not point toward the bottom, but rather toward the surface of the wastewater in a flat angle of 1 to 10°. This particularly simple and cost-effective measure makes it possible to save up to 10% of the energy required to produce and maintain a flow in a wastewater treatment tank.

According to an advantageous embodiment, the angle is 2 to 8°, preferably 3 to 5°. The use of an angle of 3 to 5°, in particular, makes it possible to save a particularly large amount of energy.

Advantageously, the wastewater treatment tank is a circulation basin, wherein the horizontal mixer produces a circulating flow. A circulation basin comprises a circumferential channel. The horizontal mixer can be supported on the bottom of the wastewater treatment tank. However, said horizontal mixer can also be mounted so as to be suspended from a bridge or the like, which extends over the wastewater treatment tank or the channel.

According to a further advantageous embodiment of the invention, an aeration device for aerating the wastewater is provided on the bottom. This can involve conventional plate-type aeration devices, perforated hoses, or the like. The aeration device is advantageously provided downstream of the horizontal mixer. This makes it possible to particularly intensively mix the wastewater with the air introduced by means of the aeration device.

According to the method-related aspect of the invention, the horizontal mixer is arranged such that the axis of the propeller shaft is tilted relative to the bottom by an angle of 1 to 10° in such a way that a flow directed toward a surface of the wastewater is produced by the horizontal mixer.

Reference is made to the aforementioned embodiments of the arrangement with respect to the advantages that can be obtained with the method and with respect to the advantageous embodiments. The same advantages are obtained with the method. The advantageous embodiments described with respect to the arrangement also similarly form advantageous embodiments of the method.

According to the method-related aspect of the invention, conventional horizontal mixers can also be retrofitted particularly easily such that energy for producing a flow in a wastewater treatment tank can thereby be saved. For example, a horizontal mixer supported on the bottom of the wastewater treatment tank can be tilted by placing wedges or other suitable support means underneath said horizontal mixer such that the axis of the propeller shaft is slanted relative to the bottom by an angle of 1 to 10°, thereby making it possible to produce a flow pointing in the direction of the wastewater surface. The axis of a propeller shaft of a suspended horizontal mixer can also be tilted according to the invention in order to thereby produce a flow pointing from the bottom toward the surface of the wastewater.

According to a further advantageous embodiment of the method, the horizontal mixer arranged according to the invention produces a circulating flow having a velocity of 0.25 to 0.40 m/s, preferably 0.27 to 0.37 m/s.

Exemplary embodiments of the invention are described in greater detail in the following by reference to the drawings. Therein:

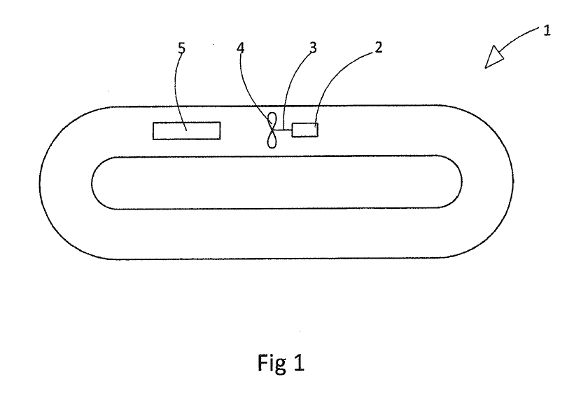

FIG. 1 shows a top view of a wastewater treatment tank,

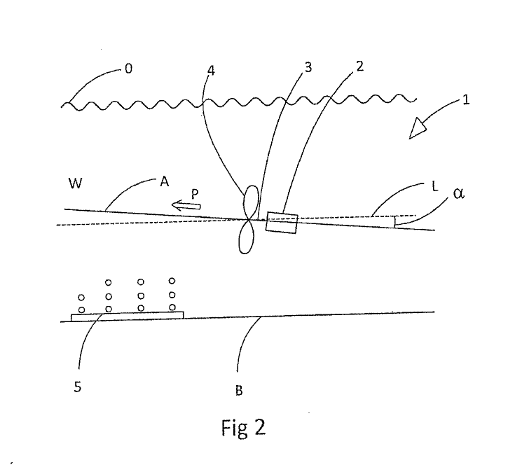

FIG. 2 shows a schematic side view of a first arrangement,

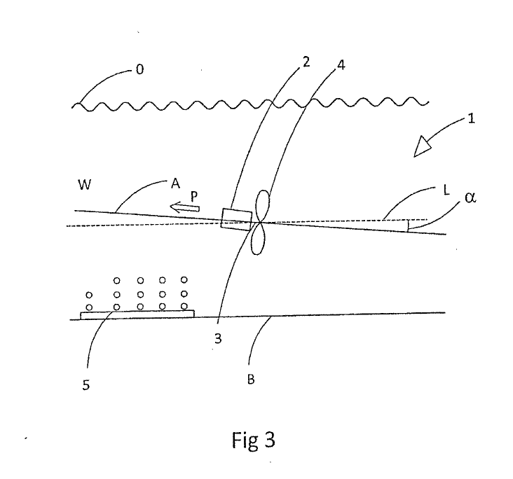

FIG. 3 shows a schematic view of a second arrangement, and

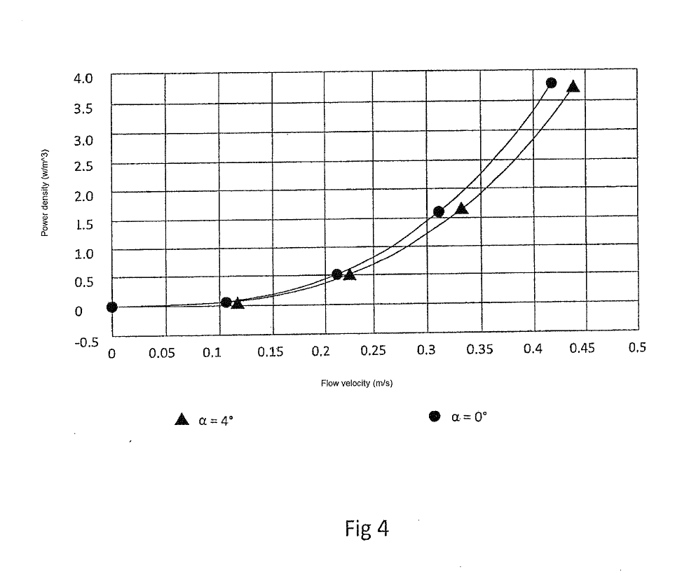

FIG. 4 shows the power density plotted over flow velocity of a conventional arrangement and an arrangement according to the invention.

FIG. 1 shows a top view of a wastewater treatment tank labeled in general with reference sign 1. This is a circulation basin formed by a circumferential channel. A horizontal mixer having a motor 2 is provided in the wastewater treatment tank 1, wherein a propeller shaft 3 having a propeller 4 mounted thereon extends from said horizontal mixer. An aeration device 5 is provided downstream of the horizontal mixer.

FIG. 2 shows a schematic side view of a first arrangement for producing a flow in the wastewater treatment tank 1. The wastewater treatment tank 1 has a substantially horizontal bottom B. An axis of the propeller shaft 3 is designated with the reference sign A. The dashed line L is a line extending parallel to the bottom B. The line L forms an angle α of 4°, for example, with the axis A. The arrow P designates a flow direction of a flow produced by the horizontal mixer.

As is evident from FIG. 2, the flow direction P points toward a surface O of the wastewaster W accommodated in the wastewater treatment tank 1. The axis A is tilted opposite the flow direction P, in the direction toward the base B, by an angle α.

In the further arrangement, which is shown in FIG. 3, the motor 2 is disposed downstream of the propeller 4. That is, the propeller 4 is configured and operated in this case such the propeller 4 produces a flow having the flow direction P in the direction of the motor 2. In this case as well, the axis A of the propeller shaft 3 is tilted relative to the bottom B by the angle α. The tilt of the axis A extends in the direction of the bottom B opposite the flow direction P.

In FIG. 4, the power density of a conventional horizontal mixer (round measurement points) and of a horizontal mixer according to the invention (triangular measurement points) are plotted over the flow velocity generated thereby in each case. Advantageously, flow velocities of 0.30 to 0.35 m/s are produced in a wastewater treatment tank, in particular in a circulation basin.

As is evident from FIG. 4, tilting the axis A by an angle α of approximately 4° enables the power density for producing a flow velocity in the range of 0.30 to 0.35 m/s to be reduced by approximately 10%. As a result, an energy savings of 10% compared to conventional arrangements or methods can be achieved with the arrangement according to the invention and the method according to the invention.

### LIST OF REFERENCE SIGNS

1 wastewater treatment tank

2 motor

3 propeller shaft

4 propeller

5 aeration device

A axis

B bottom

L line

O surface

P flow direction

W wastewater

α angle

1-10. (canceled)

11. An arrangement for producing a flow in a wastewater treatment tank, comprising a substantially horizontal bottom and a horizontal mixer, which is provided in the wastewater treatment tank and which has a propeller driven by means of a propeller shaft,
wherein the wastewater treatment tank is a circulation basin formed by a circumferential channel and a circulating flow is produced by the horizontal mixer, wherein the axis of the propeller shaft is tilted relative to the bottom by an angle α of 3 to 5° in such a way that a flow directed toward a surface of the wastewater is produced by the horizontal mixer.

12. The arrangement according to claim 11, wherein an aeration device for aerating the wastewater is provided on the bottom.

13. The arrangement according to claim 11, wherein the aeration device is provided downstream of the horizontal mixer.

14. A method for producing a flow in a wastewater treatment tank, comprising a substantially horizontal bottom and a horizontal mixer, which is provided in the wastewater treatment tank and which has a propeller driven by means of a propeller shaft,
Wherein the wastewater treatment tank is a circulation basin formed by a circumferential channel and a circulating flow is produced by the horizontal mixer, wherein the horizontal mixer is arranged such that the axis of the propeller shaft is tilted relative to the bottom by an angle α of 3 to 5° in such a way that a flow directed toward a surface of the wastewater is produced by the horizontal mixer.

15. The method according to claim 14, wherein a circulating flow having a velocity of 0.25 to 0.40 m/s, preferably 0.27 to 0.37 m/s is produced.

16. The method according to claims 14, wherein the wastewater is aerated by means of an aeration device provided on the bottom.
